(19) United States
(12) Patent Application Publication
(10) Pub. No.: US 2011/0228933 A1
(43) Pub. Date: Sep. 22, 2011

(54) METHOD AND SYSTEM FOR PROTECTING AN INFORMATION SIGNAL USING A CONTROL WORD

(75) Inventor: Christian BENARDEAU, Bussy Saint Georges (FR)

(73) Assignee: LOGIWAYS FRANCE, Paris (FR)

(21) Appl. No.: 13/049,163

(22) Filed: Mar. 16, 2011

(30) Foreign Application Priority Data
Mar. 17, 2010 (FR) 10 51896

(51) Int. Cl. H04N 7/167; H04L 9/00

(52) U.S. Cl. 380/239; 380/255

(57) ABSTRACT

This method for protecting an information signal using a control word, the information signal and control word being sent by a transmitter to one or several receivers (7), the transmitter carrying out a step for encrypting the information signal using the control word (CW) and a step for encrypting the control word (CW) in an access control module before sending them to the receiver(s) (7) and the or each receiver (7) carrying out a step for unscrambling the control word and a step for unscrambling the information signals using the control word, is characterized in that the transmitter carries out an additional encryption step for encrypting the control word (CW) using an additional access control module, and in that the receiver (7) carries out an additional unscrambling step for unscrambling the control word using an additional security module (16).

The present invention relates to a method and a system for protecting an information signal using a control word.

Such methods and such systems are for example implemented in secured access verifications used to broadcast paid television signals.

In such systems, the television signals are encrypted at a broadcast headend using a control word (CW) provided by a random generator. This control word is then entered into means for encrypting the television signals before they are transmitted by the headend to the corresponding receivers.

The control word is also sent to access control means that are used to encrypt said control word and send it to corresponding receivers in an entitlement control message (ECM).

In the state of the art, these different signals are then sent to corresponding receivers that are equipped with means making it possible, on one hand, to recover the television signals and, on the other hand, the ECM messages.

The ECM messages are then unscrambled using a security module that can for example assume the form of a chip card inserted into a corresponding decoder, to recover the control word. This control word is then entered into means for unscrambling the television signals received by the receiver in order to deliver the television signals in clear.

It is known, however, that these mechanisms are subject to intense piracy.

In particular, one very widespread form of piracy consists of recovering the control word at the output of the security module and broadcasting it widely, for example through the Internet.

This control word is in fact relatively easy to detect by placing a probe at the interface between the security module and the rest of the receiver.

Various attempts have already been made to try to resolve this problem.

In particular, pairing techniques have been used with the security module and the rest of the receiver.

These pairing techniques consist of encrypting the control word between the security module and the rest of the receiver using a key, for example shared and common between the chip card and the receiver.

Moreover, this protection technique cannot be implemented for older-generation receivers.

The aim of the invention is therefore to resolve this problem.

To that end, the invention relates to a method for protecting an information signal using a control word, said information signal and control word being sent by a transmitter to one or several receivers, the transmitter carrying out a step for encrypting the information signal using the control word (CW) and a step for encrypting the control word (CW) in an access control module before sending them to the receiver(s) and the or each receiver carrying out a step for unscrambling the control word and a step for unscrambling the information signals using said control word, characterized in that the transmitter carries out an additional encryption step for encrypting the control word (CW) using an additional access control module, and in that the receiver carries out an additional unscrambling step of the control word using an additional security module.

The invention also relates to a system for protecting an information signal using a control word, said information signal and control word being sent by a transmitter to one or several receivers, the transmitter including means for encrypting the information using a control word and means for encrypting the control word before sending them to the receiver(s), and the or each receiver includes a security module for unscrambling the control word and means for unscrambling information using said control word, characterized in that the transmitter includes additional means for encrypting the control word at the output of the encrypting means and in that the or each receiver includes an additional unscrambling security module corresponding to the control word.

According to other aspects of the invention, the system for protecting an information signal comprises one or more of the following features:
the security module is adapted to be removably inserted into the receiver while the additional security module is integrated into the receiver, and
the information signals are television signals.

The invention will be better understood using the following description provided solely as an example and done in reference to the appended drawings, in which:

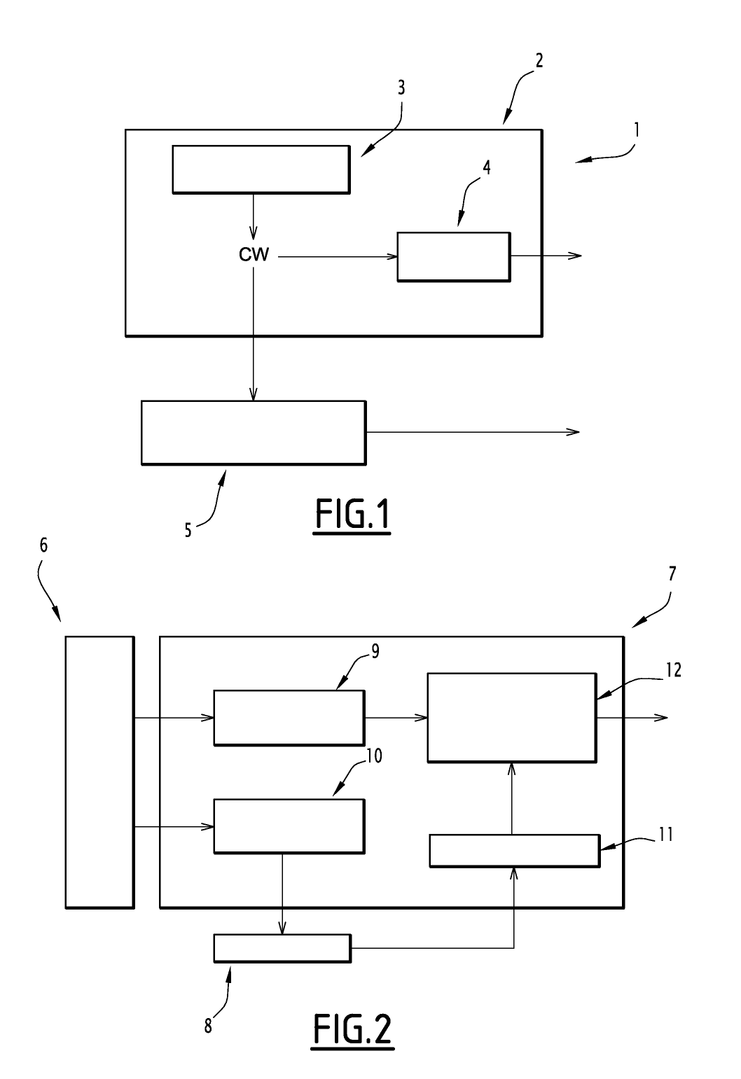

FIG. 1 shows a synoptic diagram illustrating one embodiment of a headend transmitting encrypted information signals of the state of the art,

FIG. 2 shows a synoptic diagram of a receiver for such signals of the state of the art for older-generation receivers, and

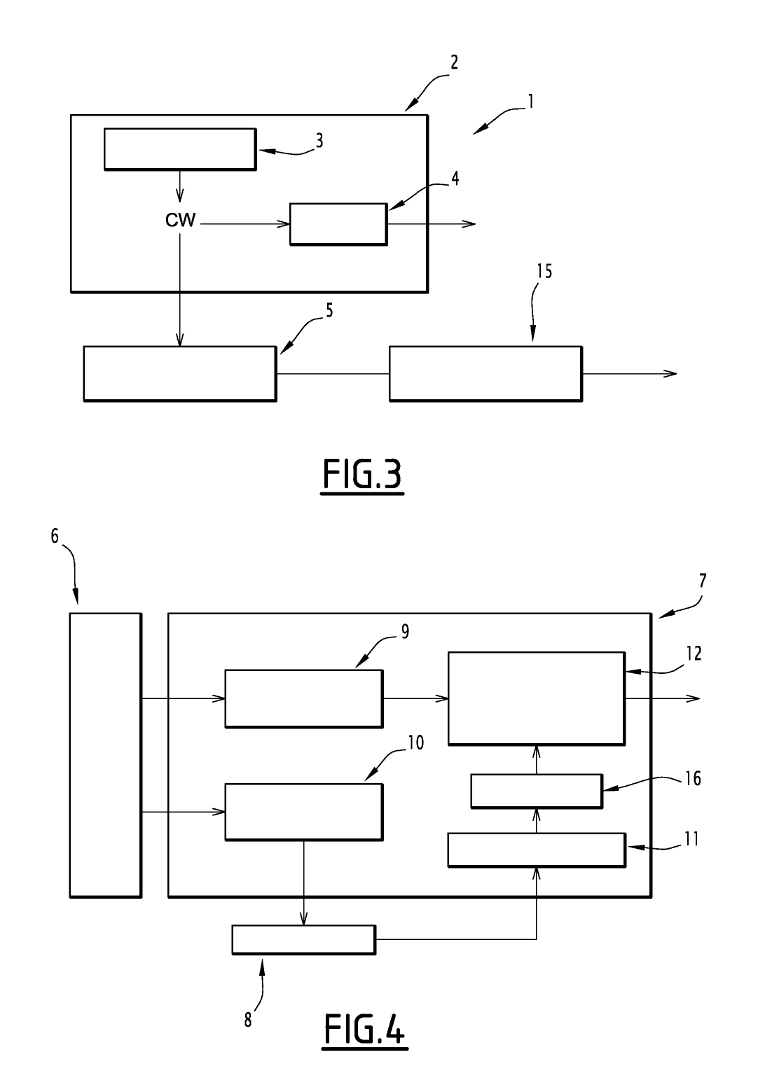

FIGS. 3 and 4 respectively show synoptic diagrams of a headend and a receiver implementing a method and a system according to the invention.

FIG. 1 shows an information broadcasting headend, in particular for television signals.

This headend is designated by general reference 1 in this figure and for example includes a signal scrambler designated by general reference 2. This scrambler uses a control word (CW), in the state of the art, provided by a corresponding random generator designated by general reference 3, to encrypt, using an audio/video encrypting module for example of the DVB-CSA type designated by general reference 4, the television signals that are emitted.

Moreover, the control word is entered into an access control module designated by general reference 5 to be encrypted there and is then transported traditionally in a message called ECM to the receivers.

This information is then sent to corresponding receivers, a synoptic diagram of which is shown in FIG. 2.

The information received at said receiver is designated by general reference 6, the receiver being designated by general reference 7.

As will be described in more detail later, this receiver is also associated with a security module designated by general reference 8, for example assuming the form of a chip card or another form, and implementing at least in part data unscrambling means, as will be described in more detail later.

The receiver then includes two different filters, one designated by general reference 9, making it possible to recover the information signals, e.g. television signals, to be unscrambled, and the other designated by general reference 10, making it possible to recover the so-called ECM messages.

It will be recalled that the control word CW encrypted during the transmission by the headend is contained in these ECM messages.

The recovered ECM messages are then sent to the security module 8, which makes it possible to recover and unscramble the control word CW in them. Once recovered, this control word is resent to the receiver 7, in clear between the security module 8 and an input log designated by general reference 11, making it possible to deliver, to an unscrambling module designated by general reference 12, this control word, so as to unscramble the information such as the television signals, for example.

As previously indicated, the control word CW is sent in clear between the security module, i.e. for example between the chip card, and the rest of the receiver.

However, it is very easy to recover this control word so as to distribute it to pirates.

The aim of the invention is to resolve this problem.

FIGS. 3 and 4 respectively show a headend and a receiver that implement the inventive method and system.

For simplification, identical reference numbers designate members identical or similar to those illustrated in FIGS. 1 and 2, respectively.

Thus FIG. 3 shows the headend designated by general reference 1, the signal scrambler 2, the random control word generator 3, the encrypting module 4, and the access control module 5.

According to the invention, the output of this access control module 5 that encrypts the control word CW a first time is entered into an additional access control module designated by general reference 15 in this figure, which then applies an over-encryption or additional encryption to the control word encrypted by the first access control module 5.

The output of this additional access control module 15 then delivers an encrypted and over-encrypted control word, i.e. encrypted a first time by the access control module 5 and over-encrypted by the access control module 15. Conventionally, this information is then sent in an ECM message to the corresponding receivers.

A receiver implementing the inventive method and system is illustrated in FIG. 4, in which we see the receiver 7, the entering signals 6, the filter 9 making it possible to recover the encrypted television signals, the filter 10 making it possible to recover the ECM messages, the unscrambling module 12, the log 11, and the security module 8 still made up for example of a chip card adapted to be removably inserted into the receiver/decoder.

The security module 8 is then adapted to recover, in the ECM messages, the control word broadcast by the headend, by applying a first unscrambling step corresponding to the encrypting done by the first access control module 5 in this headend.

At output, the security module 8 then delivers, to the rest of the receiver 7, a control word that remains encrypted according to the encrypting done by the additional access control module 15.

It is then clear that the information relative to the control word circulating between the security module 8 and the rest of the receiver 7 is no longer of any interest to pirates, inasmuch as the control word remains encrypted.

Conventionally, this encrypted control word is then delivered to the log 11, which applies it to an additional security module designated by general reference 16 in that figure, which is adapted to it to unscramble and recover the control word in clear and deliver it to the unscrambling means of the television signals 12.

This second security module then performs an additional step for unscrambling the control word opposite the encrypting step carried out by the additional access control module 15.

The information useful for this unscrambling is sent conventionally, in the ECM messages.

It will be noted that, unlike the first security module 8, this second security module 16 is integrated into the corresponding receiver 7 and is for example inserted between the log 11 and the unscrambling module of the signals 12 directly upstream thereof and its output is therefore not directly accessible to pirates. It is then much more difficult for pirates to recover this control word in order to distribute it.

Different methods of installing this second module can be considered.

The idea at the base of the present invention thus consists of over-encrypting the control word contained in the ECM messages, for example using mathematical processing that can easily be installed in the components already in place.

In this description, the terms encryption and unscrambling have been used generally to designate all possible operations to protect the concerned data and must not be understood as limiting the scope of the invention solely to the encryption of said data.

Indeed, various protection, such as by using an OUEX, for example, can be considered.

Likewise, and although the security module has been described as a chip card that can be removably engaged in the receiver, other embodiments can be considered such as, for example, an onboard software embodiment thereof.

This is also the case for the additional security module, which has been shown in the form of an intellectual property core but could also be made in the form of software and placed directly onboard in the receiver and more particularly in the unscrambling means thereof.

This then makes it possible to greatly improve the operating security of this type of system and to reduce piracy.

1. A method for protecting an information signal using a control word, said information signal and control word being sent by a transmitter (1) to one or several receivers (7), the transmitter (1) carrying out a step for encrypting the information signal using a control word (CW) and a step for encrypting the control word (CW) in an access control module (5) before sending them to the receiver(s) (7) and the or each receiver (7) carrying out a step for unscrambling the control word and a step for unscrambling the information signals using said control word, characterized in that the transmitter (1) carries out an additional encryption step for encrypting the control word (CW) using an additional access control module (15), and in that the receiver (7) carries out an additional unscrambling step of the control word using an additional security module (16).

2. A system for protecting an information signal using a control word, said information signal and control word being sent by a transmitter (1) to one or several receivers (7), the transmitter including means (4) for encrypting the information using a control word (CW) and means (5) for encrypting the control word, before sending them to the receiver(s), and the or each receiver (7) includes a security module (8) for unscrambling the control word and means (12) for unscrambling the information using said control word, characterized in that the transmitter (1) includes additional means (15) for encrypting the control word at the output of the encrypting means (5) and in that the or each receiver (7) includes an additional unscrambling security module (15) corresponding to the control word.

3. The protection system according to claim 2, characterized in that the security module (8) is adapted to be removably inserted into the receiver (7) while the additional security module (15) is integrated into the receiver.

4. The protection system according to claim 2, characterized in that the information signals are television signals.

5. The protection system according to claim 3, characterized in that the information signals are television signals.
